(19) United States
(12) Patent Application Publication
(10) Pub. No.: US 2013/0063718 A1
(43) Pub. Date: Mar. 14, 2013

(54) DEVICE FOR THE OPTICAL MEASUREMENT OF A PHYSICAL PARAMETER

(71) Applicants: Olivier Bernal, Toulouse (FR); Francis Bony, Lavalette (FR); Thierry Bosch, Toulouse (FR); Usman Zabit, Rawalpindi (PK)

(72) Inventors: Olivier Bernal, Toulouse (FR); Francis Bony, Lavalette (FR); Thierry Bosch, Toulouse (FR); Usman Zabit, Rawalpindi (PK)

(73) Assignee: INSTITUT NATIONAL POLYTECHNIQUE DE TOULOUSE, TOULOUSE CEDEX 4 (FR)

(21) Appl. No.: 13/696,640

(22) PCT Filed: May 10, 2011
(86) PCT No.: PCT/EP11/57559

§ 371 Date: Nov. 26, 2012

(30) Foreign Application Priority Data
May 11, 2010 (FR) 1053648

(51) Int. Cl. G01B 11/14

(52) U.S. Cl. 356/72

(57) ABSTRACT

A device (10) for the optical measurement of a physical parameter includes:
a laser light source (11) for generating a measurement beam in the direction of a target (20) and for receiving the measurement beam reflected by the target; the measurement beam travelling along an optical path whose variation depends on the physical parameter to be determined and the laser light source having an optical cavity (111);
a motion sensor (14) for the laser light source (11);
elements (15) for calculating the physical parameter from a signal measured at the laser light source (11) and a signal measured by the motion sensor (14).

This invention relates to the field of optoelectronic devices. More specifically, the invention concerns a measuring device for the optical measurement of the displacement of a target.

There are many types of devices for measuring the displacement, vibration, distance, etc. of a target, which make it possible to perform so-called non-destructive measurements, i.e. which do not deteriorate the target on which they are performed.

Optical methods are often used because they have the advantage of having no contact with the target and of being non-intrusive. They are based on transmitting a light beam from a laser light source towards a target and then measuring the changes in the optical properties of the light beam returned by the target, using suitable detection and measurement means.

Michelson-type interferometers, optical fiber interferometers and triangulation sensors are amongst the existing optical devices. Devices of these types, however, require using many optical components, which makes compact, easy-to-use and low cost sensors difficult to realize. In addition, some of these devices have a measurement range limited to a few centimeters or even millimeters.

In contrast, devices based on the optical feed-back phenomenon, generally called “self-mixing”, propose a compact, flexible and low cost realization system.

These devices are simple to realize and require only one laser light source that emits a measurement light beam to the target whose displacement is to be measured, for example. Part of the measurement beam is reflected by the target and fed back into an active cavity of the laser source, which produces interferences in the laser source's active cavity.

When there is a change in an optical path traveled by the measurement beam coming from the laser light source and encountering the target, for example because of the displacement of the target or of the change in the refraction index of the medium in which the target is located, fluctuations occur, in particular of the emitted optical power, which are caused by these interferences. These fluctuations are detected either by a photo-detector, e.g. a photodiode located on a rear side of the laser source, or directly, via a junction tension of the laser light source. The signals coming from the photodiode or the laser light source's junction tension are processed by suitable processing means and the information about the target's displacement or about the change in the refraction index of the medium is deduced therefrom. In this way, the laser source plays both the roles of a light source and that of a micro-interferometer, without requiring external optical components. However, a lens can be placed between the laser light source and the target when the target is located more than a few centimeters away.

In this way, these optical feed-back devices have the advantage of being self-aligning, compact and less costly than using traditional interferometry.

These devices, however, are particularly sensitive to parasite vibrations. Consequently, they require placing on a mounting that is stable and fixed in relation to the target, such as e.g. an optical table, to guarantee the accuracy of the measurement performed. This condition firstly causes additional costs and secondly is not suited to using these devices in real-world conditions, such as e.g. installation on industrial sites.

The goal of the invention, therefore, is to propose a measuring device based on the optical feed-back phenomenon, which answers size, performance and cost constraints, thus making its use in industrial situations realistic.

To this end, an object of this invention is a measuring device for the optical measurement of a physical parameter. The measuring device comprises:
a laser light source for generating a measurement beam in the direction of a target and for receiving the measurement beam reflected by said target; said measurement beam travels along an optical path whose variation depends on the physical parameter to be determined and said laser light source comprises an optical cavity;
a motion sensor for the laser light source;
calculation means for calculating the physical parameter from a signal measured at the laser light source and a signal measured by the motion sensor.

The optical path is defined as being a geometrical distance traveled by the light beam scaled to the refracting properties of the medium the light beam goes through, i.e. by multiplying this geometric distance by the refraction index of the medium.

The physical parameter to be determined, modifying the optical path of the measurement beam, is, for example: a variation of the refraction index of the medium in which the target is located; a stress (mechanical, heat, etc.) applied to an optical fiber located in front of the laser light source; and, preferably, a displacement of the moving target along an optical axis that goes through the laser light source.

The laser light source emits the measurement beam in the direction of the target, which reflects a portion of it. The reflected measurement beam is fed back, completely or partly, into the optical cavity of the laser light source; this produces with the emitted measurement beam interferences in said cavity.

Preferably, the laser light source is a laser diode, but it is possible to use any other type of laser light source, such as e.g. a gas laser.

When the optical path traveled by the measurement beam changes, the interferences induced generate, in particular, a change in the optical power of the incident beam emitted by the laser diode.

The signal measured at the laser light source depends on this variation of the optical power of the measurement beam. This variation depends on the variation in the optical path. The measured signal is, for example, a voltage, a current or a digital signal.

The motion sensor advantageously makes it possible to measure the displacement in relation to the movements of the laser light source in operation. These movements can, for example, be displacements of the laser light source inherent to the requirements of the application or parasite displacements caused by the laser light source being subjected to vibrations.

The motion sensor is a device able to measure the displacement of the laser light source in operation, such as e.g. an accelerometer, a gyroscope or an optical sensor.

When the motion sensor is an accelerometer, for example, it is preferably placed as close as possible to the laser light source and fastened to it. When the motion sensor is a contactless sensor, e.g. optical, it can be placed at a distance and its light beam pointed in the direction of the laser light source.

The signal measured by the motion sensor depends on the displacement of the laser light source. The measured signal is, for example, a voltage, a current or a digital signal.

Calculation means make it possible to determine the physical parameter from the signal measured at the laser light source and the signal measured by the motion sensor.

The calculation means comprise:
a first conversion means for converting the signal measured at the laser light source into a measurement of the optical path variation, called “measurement of the total variation in the optical path”;
a second conversion means for converting the signal measured by the motion sensor into a measurement of the displacement of the laser light source, called “displacement measurement”.

The measurement of the total variation in the optical path takes into account both the measurement of the actual variation in the optical path and the displacement measurement.

In a preferred embodiment of the invention, the calculation means also comprise calibration means for calibrating the motion sensor with respect to the laser light source.

In an example of realization, the calibration means consist in compensating the error on the gain of the motion sensor and in temporally synchronizing the measuring chain of the laser light source and the measuring chain of the motion sensor.

In one embodiment of the measuring device, the calibration means are placed, in the motion sensor's measuring chain, at the output of the second conversion means.

In one embodiment of the measuring device, to improve the signal-to-noise ratio, the measuring device comprises a photodiode at the output of the laser light source, upstream of the first conversion means, and the signal measured at the laser light source is a signal acquired by the photodiode.

In a preferred embodiment of the measuring device, when the laser light source is a laser diode, the photodiode is built into a same housing as the laser diode.

In another embodiment of the measuring device, when the laser light source is a laser diode, the signal measured at the laser diode is a signal acquired by amplifying said laser diode's junction tension.

In another embodiment of the measuring device, when the target is placed at a distance of more than a few centimeters from the laser light source, the measuring device comprises a lens placed on the optical axis XX′, between the laser light source and the target. The lens, which is preferably convex, makes it possible to focus/collimate the measurement beam. Said lens may be an adaptive lens for automated collimation/focusing.

In another embodiment of the measuring device, to improve its resolution, said measuring device comprises an electro-optical modulator able to modulate the measurement beam's phase, between the laser light source and the target.

According to another aspect, the invention relates to a method for measuring a physical parameter with a laser measurement.

The method comprises the following steps:
emission by the laser light source of a measurement beam in the direction of the target;
measurement of a signal representing the total variation in the optical path at the laser light source;
measurement by the motion sensor of a signal representing the displacement of the laser light source during the measurement at the laser light source;
determination of the total variation in the optical path by the first conversion means, from the signal measured by the laser light source.
determination of the displacement of the laser light source by the second conversion means, from the signal measured by the motion sensor;
determination of the physical parameter from the total variation in the optical path and the displacement of the laser light source.

The measurement at the laser light source of the signal representing the total variation in the optical path and the measurement of the signal representing the displacement of the laser light source by the motion sensor are realized in synchronous manner with a single origin.

The implementation order of the step in which the total variation in the optical path is determined by the first conversion means, from the signal measured at the laser light source, and of the step in which the displacement of the laser light source is determined by the second conversion means, from the signal measured by the motion sensor, is not imposed and, depending on the method, can be performed in the opposite order from that described or preferably realized simultaneously, without changing the result of said steps.

The invention also relates to the use of the optical measuring device for inspecting and controlling materials and manufactured parts in a non-destructive manner, as well as for their modal analysis.

The invention also relates to the use of the optical measuring device for measuring the displacements and vibrations of a target.

The invention also relates to the use of the optical measuring device for detecting changes in a gaseous and/or liquid mixture.

Among other uses for this optical measuring device are, for example: measuring random displacement of targets; monitoring join/weld; impact detection; optimization of high-speed machining; measuring mechanical stresses in materials.

The implementation of this measuring device in the uses cited above, amongst others, is within the skills of the person skilled in the art.

This optical measuring device also has the advantage that it can be used even in a moving on-board system.

In a preferred embodiment, the optical measuring device makes it possible to measure the displacement of a target along an axis XX′. Said measuring device comprises:
a laser light source for generating a measurement beam in the direction of the target and for receiving the measurement beam reflected by said target; said measurement beam travels along an optical path whose variation depends on the displacement of the target and said laser light source comprises an optical cavity;
a motion sensor for the laser light source;
calculation means for calculating the target's displacement from a signal measured at the laser light source and a signal measured by the motion sensor.

The invention also relates to a system for measuring a target's displacements along N axes, where N is greater than or equal to two, which comprises N optical measuring devices each positioned along one axis.

The description that follows, given solely as an example of an embodiment of the invention, is made with reference to the attached figures, in which:

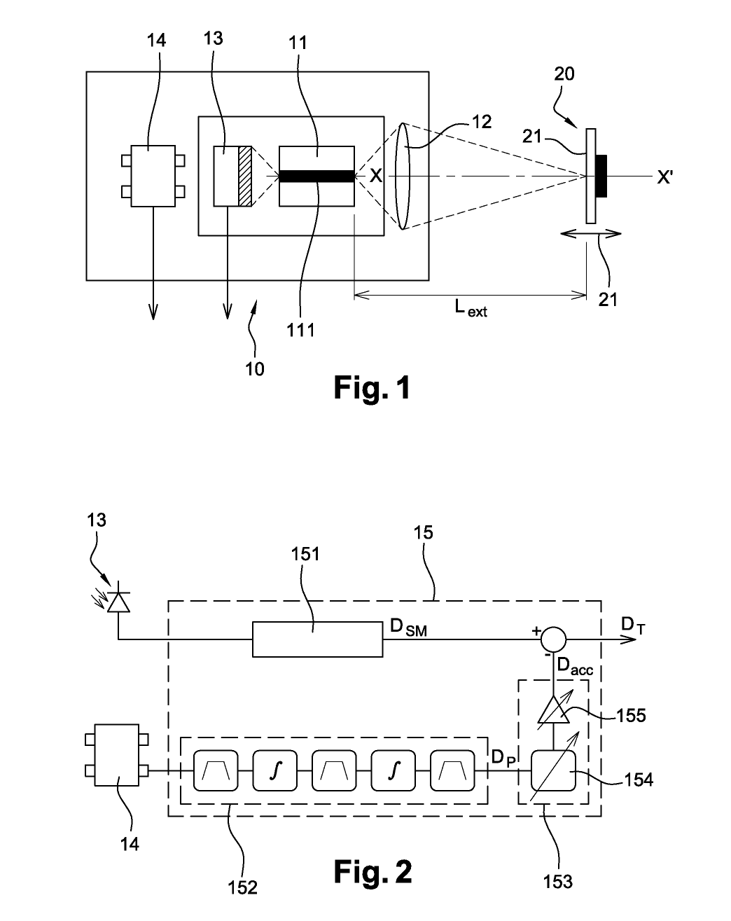

FIG. 1 illustrates schematically an example of a device for measuring the displacement of a target, based on the optical feed-back phenomenon, according to the invention;

FIG. 2 illustrates an example of signal processing of the measuring device;

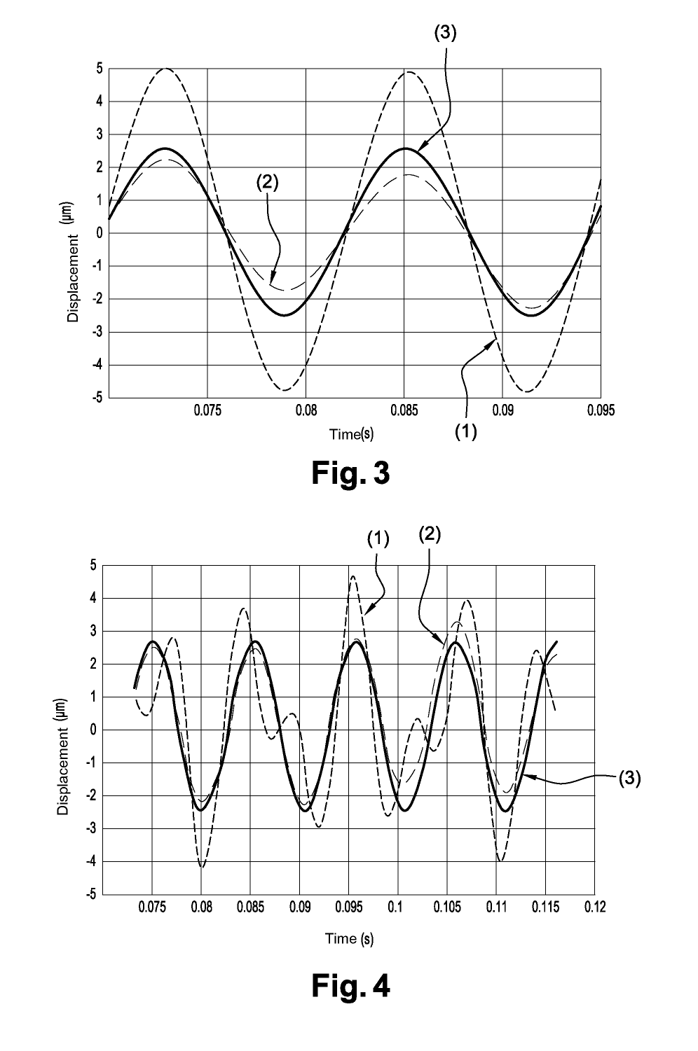

FIG. 3 illustrates the curves of measured and reconstructed displacement for a first example of operation;

FIG. 4 illustrates the curves of measured and reconstructed displacement for a second example of operation;

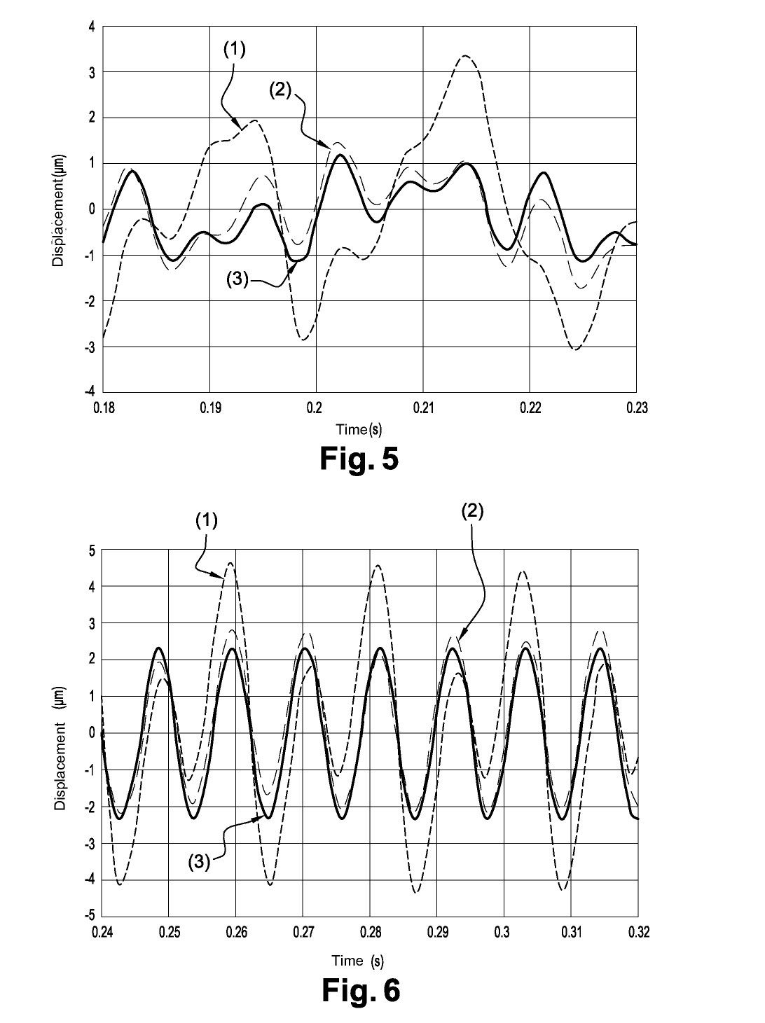

FIG. 5 illustrates the curves of measured and reconstructed displacement for a third example of operation;

FIG. 6 illustrates the curves of measured and reconstructed displacement for a fourth example of operation.

The example of realization of the measuring device is described in detail as applied to a measurement of a target's displacement. This choice is non-limiting and the invention also applies to other physical parameters, such as e.g. a variation in the optical refraction index of the medium, due to a stress being applied to an optical fiber located in front of the laser, or to a variation of a gaseous mixture between the laser and the target.

FIG. 1 illustrates schematically an optical device 10 for measuring the displacement of a target 20 according to a particular embodiment of the invention and based on the phenomenon of optical feed-back.

The device comprises a laser light source 11, a lens 12, a detector 13, a motion sensor 14 and calculation means 15 for calculating the target's displacement.

The laser light source 11, the lens 12 and the target 20 are placed on a common optical axis XX′.

The laser light source 11 is sensitive to optical feed-back; it comprises an optical cavity 111 and is designed to emit an optical measurement beam at a wavelength λ, along the optical axis XX′ in the direction of the target 20 and to receive the reflected measurement beam.

Preferably, the laser light source 11 is a laser diode, but it is possible to use any other type of laser light source, such as e.g. a gas laser.

In a preferred embodiment, the value of the current supplied to the laser diode 11 is substantially continuous over time.

In another embodiment, the laser diode 11 is supplied with variable current over time, such as periodic current, for example of sinusoidal or triangular type.

Unlike traditional interferometers, it is not required to stabilize the laser diode's wavelength using servo-control systems, which incur additional costs; the accuracy that can be obtained without servo-control is sufficiently high for many applications that require a low-cost device.

The laser diode 11 is placed at a distance Lₑₓₜ from the target.

The lens 12 is placed on an optical path traveled by the optical measurement beam and set between the laser source and the target.

Preferably, the lens 12 is used for measuring the displacement of a target at distances Lₑₓₜ greater than a few centimeters. Generally, it is not necessary for distances Lₑₓₜ of below a few centimeters.

The lens 12 is chosen firstly to receive a measurement beam coming from the laser diode 11 and to collimate/focus said measurement beam in the direction of the target and secondly to receive a portion of the measurement beam reflected by the target and to collimate/focus it towards the internal cavity 111 of the laser diode 11.

The target 20 is moving, as shown schematically as an example by the arrow 21, along the optical axis XX′.

The measuring device 10 according to the invention is thus suitable for measuring the displacement of the target 20 along the direction of the optical axis XX′.

The target 20 is designed to receive at least a portion of the measurement beam coming from the laser diode and has a surface area 21 to reflect said measurement beam.

Preferably, the surface area 21 of the target 20 is substantially flat and substantially perpendicular to the optical axis XX′ to achieve the highest possible accuracy. However, neither a flat surface area nor being perpendicular to the optical axis is essential to obtain a measurement of the target's displacement according to the invention. Other forms of surface areas can be used, provided they reflect at least a portion of the measurement beam towards the laser diode's optical cavity.

Where the displacement is not perpendicular, measuring the target's displacement will be performed according to the projection along the optical axis XX′.

In an example of realization, the target 20 can be part of an object whose displacement is to be measured.

Alternatively, the target 20 can be separate from the object but attached to the object, such that measuring the target's displacement is equivalent to measuring the object's displacement.

Consequently, the uncollimated measurement beam coming from the laser diode 11 goes towards the lens 12, which collimates/focuses it towards the target 20.

The target 20 reflects a fraction of the measurement beam.

The reflected measurement beam, after passing through the lens 12, is fed back into the optical cavity 111 of the laser diode 11; it creates interferences with the measurement beam emitted by the laser diode.

When the target 20 is moving along the optical axis XX′, the length of the optical path traveled by the beam(s), i.e. the round-trip distance between the laser diode 11 and the target 20, varies; the interferences that depend on the target's displacement generate a variation in the optical power of the measurement beam emitted by the laser diode 11.

A measurement detector 13 detects the variation in the optical power of the measurement beam emitted by the laser diode and converts it into a signal, called “SM signal”, which comprises the interferences that depend on the target's displacement. This SM signal can be, for example, a signal of amperage, of voltage, of power, a digital signal.

The measurement detector is preferably a photodiode 13. In an example of realization, the photodiode 13 is a photodiode built into the same housing as the laser diode 11 and located on a rear side of the laser diode.

This photodiode, which usually servo-controls the output power of the laser diode, is utilized to detect the variations in the laser diode's optical power, caused by the optical feed-back phenomenon.

At the output of the photodiode, as illustrated in FIG. 2, a conversion means, called first conversion means 151, processes the SM signal coming from the photodiode and converts it into a measurement of displacement called total displacement measurement D_{SM}.

This total displacement measurement D_{SM} takes into account the measurements of the target's displacement and of displacement due to the movements of the laser diode 11 when it is in operation.

In an example of realization, the first conversion means 151 uses a fringe counting method to reconstruct the total displacement D_{SM} from the SM signal. This method's accuracy is linked to the wavelength of the laser diode used.

In another example of realization, the first conversion means 151 uses a phase unwrapping method to reconstruct the total displacement D_{SM} from the SM signal.

Both methods cited above, fringe counting and phase unwrapping, are methods known per se and will therefore not be described.

The first conversion means 151 may be analog or digital, depending on the SM signal.

The measuring device 10 also comprises a motion sensor 14. In a preferred example of realization, this motion sensor is an accelerometer located near the laser diode 11 and preferably fastened to the laser diode. According to the invention, the accelerometer 14 is advantageously used to measure the displacement due to the movements of the laser diode 11.

The accelerometer 14 can be for example of an optical or piezoelectric type. In a preferred example of realization, the accelerometer is an accelerometer based on microelectromechanical systems, called MEMS. MEMS-based accelerometers are small and advantageously allow said accelerometer to be positioned very close to the laser source.

The displacement caused by the laser diode's movements is measured indirectly by measuring the acceleration of the laser source by the accelerometer.

At the output of the accelerometer, a conversion means called second conversion means 152 processes a signal, called “acceleration signal”, which comes from the accelerometer and converts it to a measurement of the displacement of the laser diode, called “displacement measurement Dₚ”

The acceleration signal can be, for example, a signal of voltage, a digital signal.

In an example of second conversion means, as shown in FIG. 2, said second conversion means 152 uses a method of double integration of the acceleration signal to reconstruct the displacement of the laser diode from the acceleration signal.

The second conversion means 152 may be analog or digital, depending on the acceleration signal.

At the output of the second conversion means 152, a calibration means 153 for calibrating the accelerometer 14 with respect to the laser diode 11 calibrates the measurement of the displacement of the laser diode 11.

In an example of realization of the calibration means 153, as shown in FIG. 2, said calibration means comprises a variable gain system 154 to allow compensating for the accelerometers own gain errors and a phase shifter 155 to synchronize the two measuring chains, i.e. the laser diode measuring chain and the accelerometer measuring chain.

The reconstituted actual displacement D_{T} of the target 20 is then determined by a subtraction of the total displacement measurement D_{SM} obtained by the laser diode subjected to a movement and the calibrated displacement measurement D_{acc} obtained from the accelerometer.

The first and second conversion means 151, 152, as well as the calibration means 153 constitute the calculation means 15.

The measuring device 10 according to the invention makes it possible to reconstitute the measurement of the displacement of the target D_{T}. This device can be used advantageously over a wide measurement range. Indeed, the measurement range can be limited by the laser diode's coherence half-length. The measurement range can reach several meters, depending on the selected laser light source.

It is important to note here that, in this method, the measured displacement obtained by the accelerometer in the direction of the laser beam is subtracted, to correct for the laser source's parasite displacement. Both the gain and the phase of the displacement signal reconstituted from the acceleration signal are corrected to take into account the phase shifts introduced by processing the self-mixing and acceleration signals. These corrections make it possible to obtain a high level of measurement accuracy.

Since the signal processing steps performed on each of the two channels (accelerometer and self-mixing channels) are non-linear in nature (filtering, integration, derivation, etc.), the phases of the final signals on both channels are non-zero and vary over the system's entire bandwidth.

Consequently, a simple direct subtraction of the two final signals by the person skilled in the art does not allow a correct evaluation of the target's displacement to be obtained.

As a result, this method comprises additional steps of calibrating and correcting the signals' respective phases.

In fact, a phase correction is more important than a gain correction; a large phase difference between the two final signals leads to a very poor signal obtained after subtraction.

The phase correction between the two final signals can be obtained by different means, three of which are listed below as a non-limiting example:

1) An analog all-pass filter can be used with a customized phase relationship, designed to correct the phase of one of the two final signals in relation to the other signal.

2) A digital filter with a customized phase relationship can be used to get the phase of one signal to correspond to the other. Such a solution could imply additional costs for analog-digital and digital-analog conversions.

However, a very accurate phase relationship can be realized with digital data.

3) A spectral analysis of the last two signals makes it possible to obtain the relationship between these two signals. A correction can then be realized by modifying these spectra such that the resulting two signals are in phase.

This gain and phase correction is not sufficient, however, if resolutions close to the laser sensor's intrinsic resolution are desired, as is the case of this method. In effect, two distinct phenomena can cause errors:
noise from the accelerometer,
the coupling between the various axes of the accelerometer.

The accelerometer noise is considered first. During the double integration process required to obtain the displacement signal from the acceleration signal, the noise from the acceleration sensor is also subjected to this double integration.

This is why there is an increase of the noise of the displacement signal reconstituted in this way in 1/f2, where f is the frequency being considered.

To avoid the resulting low-frequency drifts of the sensor (random walk) this method comprises a step of filtering the signal coming from the accelerometer using a high-order high-pass filter.

In general, the low cut-off frequency of this filter is set by the maximum error that the system can tolerate.

For example, with a linear accelerometer of a type known under the brand name LIS344ALH (registered trademark) from ST (registered trademark), this frequency is 20 Hz to obtain a correction with a resolution equal to that of the self-mixing, i.e. 50 mm. This would be 1 Hz for a device of a type known under the brand name SF1500 (registered trademark) from Colibrys (registered trademark).

Regarding the coupling between the various axes of the accelerometer: this coupling can be caused by poor alignment, either extrinsic (in regards to the laser sensor) or intrinsic (in regards to the accelerometer's internal axes). In general, the coupling is below 2%. It should be noted that this coupling is observed, whether the accelerometer has a single axis, two axes or three axes.

Accordingly, if the interference (parasite vibration) applied to the laser is mainly oriented along an axis perpendicular to that of the laser beam, the information supplied by the accelerometer is compromised.

The method described here as a non-limiting example thus comprises a step of calibrating the accelerometer in relation to the coupling between the axes, which is necessary to be able to guarantee the desired resolution.

To illustrate the reconstituted displacement of the target from the measuring device according to the invention, many experiments have been realized and are summarized below in the form of four examples.

In all the experiments:
the laser light source is a laser diode of the type known under the brand name HL 7851G (registered trademark) from Hitachi (registered trademark) that emits at a wavelength λ, of 785 nm with a built-in photodiode. A 30 mA constant injection current is supplied to the laser diode, which has a maximum output power of 50 mW;
the acceleration sensor is an accelerometer of the type known under the brand name ADXL311 (registered trademark) from Analog Devices (registered trademark) with a resolution of 300 μg/√Hz and a 5 kHz bandwidth;
the vibrations/displacement likely to be for example parasitic for the laser diode are generated by a shaker to which the laser diode and the accelerometer are attached;
the target is positioned at a distance of 45 cm from the laser diode and its displacement is generated by a piezoelectric sensor type P753.2CD by Physik Instrumente®. This piezoelectric sensor is coupled to a capacitive sensor to measure directly the displacement of the piezoelectric sensor at a resolution of 2 nm.

To obtain the gain and phase calibration coefficients for the calibration means, a phase of calibrating the measuring device according to a particular embodiment of the invention is used in this example of realization to achieve better resolution. During this calibration phase, only the laser diode moves, helped by the shaker in this example, whereas the target is immobile. Four sets of measurements were realized between 20 Hz and 400 Hz in 20 Hz steps. The signals extracted from the accelerometer and the laser diode are compared to obtain the gain and phase calibration coefficients and are stored in a table of values. After this calibration phase, the phase error measured is below 2° and the gain error measured is below 3%.

Four experiments will now be presented. The results obtained are illustrated respectively in FIGS. 3, 4, 5 and 6. For each figure:
curve 1 illustrates the total displacement signal reconstructed from the signals obtained by the laser diode;
curve 2 illustrates the actual displacement signal reconstructed from the signals obtained by the laser diode and the accelerometer;
curve 3 illustrates the target's displacement signal: it is the reference curve.

### Example 1

### The Target and the Shaker Vibrate in a Sinusoidal Way at the Same Frequency

In this first example, the shaker and the target vibrate at an identical 81 Hz frequency, with a signal amplitude of 3.5 μm and 2.5 μm respectively.

The results are obtained in FIG. 3.

It can be seen that for curve 1, the displacement amplitude has an error of 5 μm, whereas curve 2 is close to curve 3.

This first example makes it possible to show that the measuring device according to the invention allows the actual displacement of the target to be reconstituted, even in the presence of a vibration of the same frequency. This can occur often where there is an undesirable mechanical coupling between the measuring device and the vibrating target.

### Example 2

### The Target and the Shaker Vibrate in a Sinusoidal Way at Different Frequencies

In this second example, the shaker vibrates at a frequency of 167 Hz with a signal amplitude of 2 μm and the target vibrates at a frequency of 97 Hz with a signal amplitude of 2.5 μm.

The results are obtained in FIG. 4.

It can be seen in this second example that, for curve 1, the displacement signal is distorted, whereas curve 2 is close to curve 3.

### Example 3

### The Target and the Shaker Vibrate in Random Fashion

The shaker vibrates at a combination of frequencies: 46 Hz-92 Hz-194 Hz-276 Hz.

The target vibrates at a combination of frequencies: 26 Hz-104 Hz-216 Hz.

The results are obtained in FIG. 5.

It can be seen in this third example that, for curve 1, the displacement signal is highly distorted with large amplitudes, whereas curve 2 is again close to the reference curve 3.

### Example 4

### The Target Vibrates in a Sinusoidal Way at a Fixed Frequency and the Shaker Vibrates in Random Fashion

The shaker vibrates at a combination of frequencies: 46 Hz-92 Hz-194 Hz-276 Hz.

The target vibrates at a frequency of 91 Hz with an amplitude of 2.3 μm.

The results are obtained in FIG. 6.

It can be seen in this fourth example that, for curve 1, there is obtained a distorted displacement signal and a large amplitude, whereas curve 2 is again close to the reference curve 3.

The measuring device according to the invention makes it possible to advantageously reduce the error in the measurement of the target's displacement using an optical feed-back sensor, caused by the displacement of the laser diode.

The measuring device according to the invention is a device that is simple to realize, small in size, self-aligned and robust, for measuring displacement with an accuracy of 300 nm for this realization using the Analog Devices ADXL311 type of accelerometer. It also has the advantage of being affordable and transportable into industrial environments.

In one realization variant of the invention, a measurement system can be envisaged that is made up by associating at least two optical measuring devices 10, positioned along different axes, to jointly measure transversal displacements of the target 20.

In an example of realization, when the assembly is made of two optical measuring devices 10 positioned along two different axes, the displacement of the target 20 is then determined in two dimensions, within a plane formed by the two axes.

In another example of realization, when the assembly is made of three optical measuring devices 10 positioned along three different axes, the displacement of the target 20 is then determined in three dimensions.

1. Measuring device (10) for the optical measurement of a physical parameter characterized in that said measuring device comprises:
a laser light source (11) for generating a measurement beam in the direction of a target (20) and for receiving the measurement beam reflected by said target, said measurement beam travelling along an optical path whose variation depends on the physical parameter to be determined and said laser light source comprising an optical cavity (111);
a motion sensor (14) for the laser light source (11);
calculation means (15) for calculating the physical parameter from a signal measured at the laser light source (11) and a signal measured by the motion sensor (14).

2. Measuring device according to claim 1, wherein the calculation means (15) comprise a first conversion means (151) for converting the signal measured at the laser light source (11) into a measurement of the total variation in the optical path and a second conversion means (152) for converting the signal measured by the motion sensor (14) into a measurement of the displacement of the laser light source.

3. Measuring device according to claim 1 claims, wherein the calculation means (15) comprise a calibration means (153) for calibrating the motion sensor (14) with respect to the laser light source (11).

4. Measuring device according to claim 1, wherein the motion sensor (14) is an accelerometer.

5. Measuring device according to claim 2 that comprises a photodiode (13) at the output of the laser light source (11), upstream of the first conversion means (151).

6. Measuring device according to claim 1, wherein the laser light source (11) is a laser diode.

7. Method for measuring a physical parameter from the optical measuring device according to claim 1, characterized in that the method comprises the following steps:
emission by the laser light source (11) of a measurement beam in the direction of the target (20);
measurement of a signal representing the total variation in the optical path at the laser light source (11);
measurement by the motion sensor (14) of a signal representing the displacement of the laser light source (11) during the measurement at the laser light source;
determination of the total variation in the optical path by the first conversion means (151), from the signal measured at the laser light source (11);
determination of the displacement of the laser light source by the second conversion means (152), from the signal measured by the motion sensor (14);
determination of the physical parameter from the total variation in the optical path and from the displacement of the laser light source.

8. Method according to claim 7, wherein the optical measuring device is used for inspecting and controlling materials and manufactured parts in a non-destructive manner.

9. Method according to claim 7, wherein the optical measuring device is used for measuring a target's displacements and vibrations.

10. Method according to claim 7, wherein the optical measuring device is used for detecting variations in a gaseous and/or liquid mixture.

11. On-board system comprising a device according to claim 1.

12. Measuring device (10) for the optical measurement along an axis XX′ of the displacement of a target (20), characterized in that said measuring device comprises:
a laser light source (11) for generating a measurement beam in the direction of the target and for receiving the measurement beam reflected by said target, said measurement beam travelling along an optical path whose variation depends on the displacement of the target and said laser light source comprising an optical cavity (111);
a motion sensor (14) for the laser light source (11);
calculation means (15) for calculating the target's displacement from a signal measured at the laser light source (11) and a signal measured by the motion sensor (14).

13. System for measuring a target's displacements along N axes, where N is greater than or equal to two, which comprises N optical measuring devices according to claim 12.

14. Measuring device according to claim 2, wherein the calculation means (15) comprise a calibration means (153) for calibrating the motion sensor (14) with respect to the laser light source (11).
